(19) United States
(12) Patent Application Publication
(10) Pub. No.: US 2009/0271310 A1
(43) Pub. Date: Oct. 29, 2009

(54) System and Method for Creating and Managing Intellectual Property Investment Trusts

(76) Inventors: Peter O. Roach,, JR., Atlanta, GA (US); Christopher M. Arena, Johns Creek, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/429,737

(22) Filed: Apr. 24, 2009

Related U.S. Application Data
(60) Provisional application No. 61/047,597, filed on Apr. 24, 2008.

(51) Int. Cl. G06Q 40/00; G06Q 50/00

(52) U.S. Cl. 705/37

(57) ABSTRACT

A system and method for creating and managing a system for extracting value from intellectual property. The method includes the steps of collecting intellectual property assets in an investment vehicle, selling shares in the investment vehicle, and licensing the collected intellectual property through the investment vehicle. Shares in the investment vehicle may be traded privately or publicly.

This application claims priority to U.S. Provisional Patent Application, Ser. No. 61/047,597, filed Apr. 24, 2008 and which is hereby incorporated in its entirety by reference.

### TECHNICAL FIELD

This invention relates to a system and method for managing financial investment instruments, and more particularly to a system and method for managing publicly or privately traded intellectual property portfolio assets that enables the realization of intellectual property value.

### BACKGROUND

There are many, many patents that are owned for which no value is ever extracted. This is because (1) the patents are weak or irrelevant; (2) the patent owner does not have the means to extract value; (3) the patent owner does not want to offend potential customers with offers for licensing; (4) the patent owner does not want to face possible counterclaims from potential licensees using their own patents. Sometimes there are basic flaws in the management systems surrounding patents and other intellectual property such that owners do not know the scope or contents of their portfolios to even consider ways of extracting value.

Additionally, a secondary market for intellectual property has developed over the past decade. Patents that were developed by companies that are no longer operational have been sold at auction or otherwise disposed of by those holding a security interest in the patents. There is an imperfect market for patents and other intellectual property. In order to extract maximum value from such intellectual property, often times that intellectual property must be licensed or leveraged against competitors, customers and suppliers. However, from a business perspective, that is not always advisable. A licensing or enforcement program against a competitor could motivate that competitor to license or enforce patents in retaliation. Also, business relationships could prevent an intellectual property owner from extracting full value from customers or vendors. On the other hand, intellectual property owned by individuals or firms that are not competing in the market with their own products and services have no such business relationship concerns. Because of this imbalance, the value of intellectual property is often significantly more than can be realized by an operational company.

If the patents do become owned by non-practicing entities, they may be at a disadvantage when it comes to licensing or litigation. Such non-practicing entities may lose leverage because they may not be able to take advantage of the possibility of an injunction.

Finally, for certain technologies, patent owners have pooled their respective patent portfolios to develop patent pools. Patent pools exist for various technologies, including, for example certain MPEG standards. These patent pools typically operate openly and have published licensing rates. In addition to providing a licensing outlet for patent owners without the licensing problems outlined above, they have the additional advantage of providing a type of “one stop shopping” for potential licensees.

Patent pools may do well for the industry patent owners, however, the revenue streams split over many patent owners and many years cause a lag in the development and protection of intellectual property and the extraction and realization of value from the intellectual property. Moreover, only the investors in the particular company patent owners get to share, albeit indirectly, in this realization of value. When faced with emerging technologies, investors must research and place bets on the individual companies engaged in that technical space.

There is a need in the market for an additional and equitable way to extract value from intellectual property and for a system and method which provides the opportunity for patent and other intellectual property owners to recognize and extract the value of its intellectual property.

### SUMMARY

The invention corrects that imbalance in valuation by providing a system and method for the public trading or private placement and trading of intellectual property portfolios. The present invention describes the creation of a novel and non-obvious tradable security in intellectual property in the form of an IP Trust. The IP Trust identifies subject matter that should be admitted to the trust, identifies and assesses assets that may be candidates for inclusion in the trust, identifies investors for the trust, performs valuation services, acquires assets, sets licensing parameters, allocates and distributes tradable shares of the trust, negotiates and executes licenses to licensees with compensation through royalty streams, in-kind contributions of additional intellectual property, or through the issuance of shares of the trust (directly or indirectly) in exchange for equity contributions to the trust.

A computer system is described which creates, manages, and controls the operations of the IP Trust and regulates and allocates the financial aspects of the IP Trust on behalf of investors, intellectual property contributors, licensees, and other interested persons. The computer system may include an assessment function, a valuation function, a licensing function, a transaction and accounting function, a docketing function, a tax function, a regulatory and compliance function, and an investor relations function, among others.

The computer system may operate on a variety of networks, and includes access points and terminals used by managers, administrators, investors, licensors, and licensees.

### BRIEF DESCRIPTION OF THE SEVERAL VIEWS OF THE DRAWING

The foregoing and other aspects of the present invention will be better understood from the following detailed description with reference to the drawings.

FIG. 1 is a functional block diagram of a system constructed in accordance with the present invention;

FIG. 2 is a schematic representation of one embodiment of the system constructed in accordance with the present invention;

FIG. 3 is a flowchart illustrating one embodiment of the present invention.

FIG. 4 is an illustration showing long term value without retention and renewal of viable assets; and

FIG. 5 is an illustration showing long term value with retention and renewal of viable assets.

Other features of the invention are further apparent from the following detailed description of the embodiments of the present invention taken in conjunction with the accompanying drawing.

### DETAILED DESCRIPTION OF THE INVENTION

The present invention is directed to the creation of a public market for intellectual property portfolios. We call these portfolios Patent Estate Investment Trusts or Intellectual Property Investment Trusts and use the abbreviation IP Trust herein.

### Summary of Intellectual Property Investment Trusts

According to one embodiment of the invention, the portfolio would be created when one or more patent owners contribute one or more patents each to the portfolio. The portfolio preferably would comprise similar types of intellectual property. An IP Trust may be directed to any area of technology including but not limited to telecommunications, pharmaceuticals, chemicals, energy, software, electronics, consumer products or an IP Trust may be oriented more toward a standard such as GSM, WiFi, etc. Moreover, IP Trusts may comprise patents that are directed to anything that is patentable in accordance with the patent laws, including but not limited to systems, apparatus, articles of manufacture, methods (including business methods) and the like. For example, a portfolio comprising patents directed to a technology area such as telecommunications or a subset of telecommunications such as voice over internet protocol may comprise an IP Trust. Another example of an IP Trust may be a portfolio comprising patents directed to containers such as improvements in the design or manufacturing of aluminum cans.

Each portfolio would preferably be managed by a portfolio manager (the “Manager”). Preferably a strong management team would be put in place by the Manager and might typically comprise legal, technical, and financial functions, as well as industry contacts. The Manager's primary obligation is to drive value for the portfolio. A Manager and management team may manage more than one IP Trust.

The Manager is appointed by a board of directors. The board of directors would serve in a capacity as any type of governance board, including setting the compensation for the manager. More details about the role of the board will be set forth in the operation section below.

Ownership of IP Trusts will preferably divide into shares or other similar ownership units (hereafter referred to as Shares). The contributors of patents will be compensated for their contribution by receiving Shares in the IP Trust. The Shares may be allocated based on the relative valuation of the patent portfolio contributed by each owner. Shares will also be held by the IP Trust and administered by the manager for various purposes, including compensation of the managers, transaction currency to purchase additional intellectual property or for other purposes suitable for the manage the IP Trust and to derive value for the shareholders. Moreover, shares may be registered, issued to the public and traded on the public markets similar to shares of stock, mutual funds, or other financial instruments. It should be noted that the phrase “public markets” is a non-limiting term and may also include private equity, closed equity funds, or other financial participation beyond the original patent owners.

Owner/contributors are incented to contribute because they will realize benefits that are synergistic with other owner/contributors. For example, the owner/contributors will pool intellectual property assets in order to reach a critical mass for licensing. The IP Trust will provide real value recognition and growth of that value over time. The IP Trust becomes an enabling mechanism for industry-wide cross licensing. The contribution to the IP Trust allows the contributing party continued participation in non-organic accumulation and growth of future intellectual property. Moreover, it provides a market for future contributor's intellectual property assets while allowing the contributors to maintain some control of the intellectual property asset.

In addition to obtaining shares of the IP Trust by contributing one or more patents to the IP Trust, the contributors will also obtain a license under the patents in the IP Trust provided that its ownership share is sufficient. This concept is called the Minimum Ownership Allocation and is defined as the minimum amount of shares required for an owner to maintain a royalty-free, non-exclusive license to the patents in the IP Trust. For example, ownership of 3% or more of the shares may be the Minimum Ownership Allocation and therefore may be sufficient to obtain a license so long as the ownership level remains at that level. An owner/contributor may have an initial 30% share in the IP Trust. It would then be able to reduce its holdings through private or public sale down to the Minimum Ownership Allocation. The Minimum Ownership Allocation may be defined for each individual IP Trust. Each IP Trust may have its own Minimum Ownership Allocation percentage and the Minimum Ownership Allocation may be changed from time to time by the board of directors of the IP Trust.

Because there is a market for the trading of IP Trusts, the shares have a certain value upon their creation. The value will be a reflection of the market forces, the aggregate value of the combined intellectual property, management reputation/talent, the demand for the patents that are owned by the IP Trust, and similar factors. The IP Trust will offer licenses to the portfolio to those in the market that wish to practice under the patent portfolio. The potential licensee may have a choice to either purchase a license on a royalty basis as determined by the IP Trust manager or to buy shares of the IP Trust at a sufficient level to obtain a license. It is anticipated that some IP Trusts will generate revenue primarily based on royalty streams derived from licensing, while others will generate revenue primarily by selling shares in lieu of licenses, or a combination of the two. Thus, IP Trusts may establish a value either through licensing revenue and/or sale of equity. Assuming the equity has a market demand, the shares should appreciate in value over time.

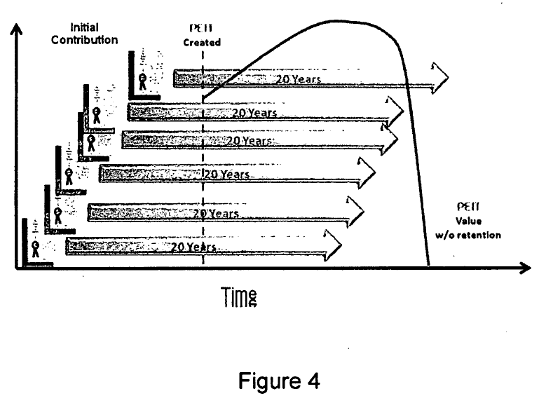

Since a traditional patent has a limited lifespan, the value of the patent typically is directly correlated with the age or the remaining life of the patent. Since the value may be dependent on the age of the individual patent and may in fact decline as the patent nears its termination, a pool or grouping of patents will typically have a value based in part on the remaining life of the individual patents in the pool or group. FIG. 4 shows the effect of this phenomenon on valuation of an IP Trust when the IP assets have a limited lifespan. For copyright assets, it is understood that the lifespan of the individual assets would be much longer.

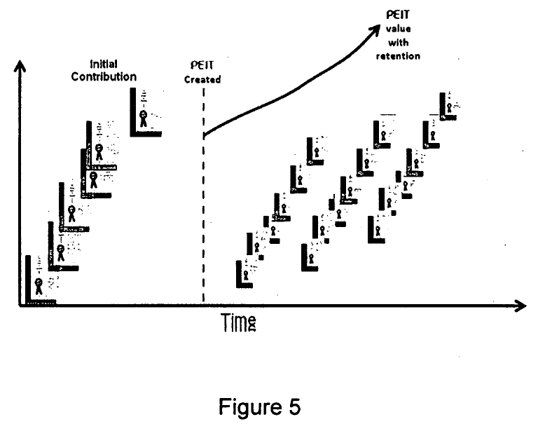

A publicly traded IP Trust has a public float of stock and thus a real value for the shares in the IP Trust. This public float provides the IP Trust with a currency to acquire additional intellectual property assets in the IP Trust. For example an IP Trust may wish to issue additional shares to acquire intellectual property assets related to the IP Trust and thus extend or increase the valuation of the IP Trust. This would allow an IP Trust to retain value over time although the initially contributed intellectual property's value may decline. FIG. 5 shows the effect on valuation when the IP Trust manager invests in additional and newly created intellectual property assets that map into the same general classification of the IP Trust. As can be seen, the effect is that the long term value continues to increase or remain steady with the addition of these newly acquired assets. It should be understood by those skilled in the art that publicly traded shares are not required, because even shares that are privately placed and traded in closed funds or with tight restrictions are able to be valued, thereby providing real valuation for the shares owned by all, including the initial contributors.

A IP Trust may also choose to trade shares in the IP Trust with a potential licensee for intellectual property assets that the licensee currently holds. In this manner the IP Trust can augment its portfolio and the potential licensee can use its current intellectual property to help offset the Minimum Ownership Allocation expenses.

Shares will also be held by the Manager and will be used as currency for the operation of the IP Trust. Shares may be sold to pay for management fees, including legal, financial, and technical fees involved in licensing the portfolio. The shares may be sold to potential licensees in order for those licensees to hold the Minimum Ownership Allocation and obtain a forward-looking royalty-free license provided the Minimum Ownership Allocation is maintained. The Manager upon approval of the Board of Directors may choose to issue new shares, even if dilutative, in order to drive value for the IP Trust.

Board of directors (BOD) positions will be available in the IP Trust. The composition and membership on the board will be determined by a number of factors. One such measure may be the ownership position of an individual or entity in the IP Trust, another might be if the individual or entity was an original contributor of intellectual property to the IP Trust. These factors may be combined to determine continued participation on the BOD. For example a particular IP Trust may be formed with the provision that each original contributor would receive a seat on the BOD and would maintain the seat on the BOD provided the individual or entity maintained an ownership of at least 5% of the IP Trust. It would then be incumbent on the individual or entity to maintain their ownership stake in the IP Trust.

In addition to creating a balanced market for patent owners, IP Trusts also create a benefit to licensees. These benefits include (1) providing a public market to help establish a real value for a license, (2) consolidating IP into a manageable pool for licensing, (3) providing an option to own an asset instead of paying a recurring licensing expense, (4) providing the ability to license future IP under the same agreement and the publicly traded shares can provide a currency for these transactions, and (5) providing a method for potential licensees to contribute IP assets to help off set licensing fees.

Investors also may receive benefits through ownership of shares in an IP Trust. For example, it permits investors to participate in the foundation of an industry segment. Ownership in the IP Trust provides a method of investing in a pure intellectual property play without the complexity of the intellectual property asset being associated with an operating entity. Similar to a mutual fund, investment in an industry sector may be accomplished without having to select individual companies. Finally, investors will get the benefit of future growth as the segment matures or the IP Trust creates value through its ongoing licensing efforts or its continued acquisition of intellectual property assets.

IP Trusts are not restricted to having the underlying intellectual property limited to patents and in fact may not even include patents. According to one embodiment, there may be a single owner IP Trust which may, for example, be a content producer such as a movie studio. The single owner may contribute its intellectual property associated with a movie, including the characters, music, and the like. Shares in the IP Trust would then be offered to the public to raise funds for the owner. The IP Trust generates revenue through the licensing and merchandising of rights. Similarly multiple owners of intellectual property could pool their assets into an IP Trust. An example might be the winners of a film festival could pool their rights in a public offering, thus sharing the risk among all of the winners and allowing the public to participate in any licensing efforts.

Rules and regulations may be adopted to guide the distribution of proceeds from the operation of the IP Trusts, measuring and controlling the tax liability of the IP Trust and creating cost efficient and attractive investment vehicles for investors. It is possible that IP Trusts would be subject to regulatory rules relating to securities and public offerings, and may even require additional legislation. Moreover, it is possible that existing or modified rules relating to patent pools and other combined business ventures such as Hart-Scott-Rodino filings may be applicable.

### System and Method for Managing and Operating IP Trusts

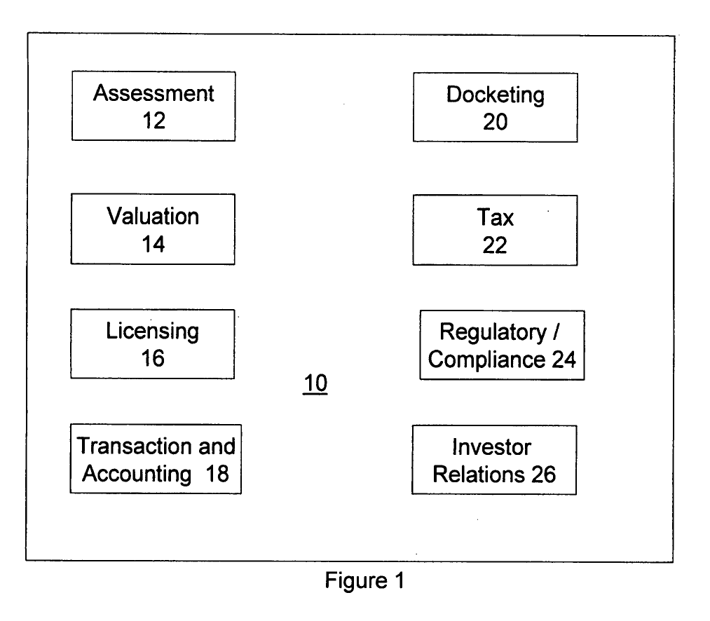

As illustrated in and with reference to FIG. 1, the system and method for managing and operating IP Trusts may include a computerized system 10 that includes as assessment module 12, a valuation module 14, a licensing module 16 and a transaction and accounting module 18. Each of those modules may be part of a single computer and computer program or be distributed across multiple computer platforms and/or multiple computer programs. The system 10 may have additional modules that assist the manager in managing the IP Trust, including a docketing module 20, a tax module 22, and a regulatory and compliance module 24, and an investor relations module 26.

The assessment tool 12 may include the criteria determined for assets that are desired for he IP Trust. Such criteria may include a variety of factors, including technology classification, age of the asset, scope of the claims of the asset as they relate to the technology, commercial viability of the technology, file history and prior art applicable to the asset. The assessment tool may automate the ability to analyze some or all of the assessment criteria. For example, the IP Trust manager may specify specific classifications and sub-classifications of patents to be included and provide an automated filter function with respect to those classifications or sub-classifications. Additionally, the assessment tool may provide a grading system, for example using a grading scale of A-D or 1-5, with an assessed value applied to each of the factors and to the asset as a whole. The criteria may include the asset obtaining at least a minimum grade on the adopted grading scale to be considered appropriate for inclusion in the IP Trust.

The valuation module 14 may include a one or more of a variety of valuation models as known by those skilled in the art. Alternatively, new valuation models developed specifically for the IP Trust may be used. The valuation module 14 may have as inputs the output of the assessment tool 10, and the valuation module 14 outputs may include a valuation number or valuation range for each asset or a valuation number or valuation range for the cumulative group of assets or a subset or combination of both.

The licensing module 16 may include the established royalty rates for royalty licensees, the established minimum ownership criteria for equity licensees, a list of potential and actual licensees or categories of such potential and actual licensees, a tracking function for determining the status of license negotiations, license status, standard license terms and conditions, and other functionality that may be helpful in managing the IP Trust.

The transaction and accounting module 18 may include a number of functions, including but not limited to on-line and off-line trading, individual account information, IP Trust performance metrics, and other functions that are helpful for participants and the IP Trust to conduct financial and/or equity transactions.

The docketing module 20 may be any type of commercial or proprietary docketing system as is known in the art. The tax module 22 may include all of the relevant federal, state and local tax codes, computational functionality to apply those tax codes to transactions and investor accounts. The regulatory and compliance module 24 may include the applicable federal, state and local regulatory requirements and functionality to track and measure compliance with those regulatory requirements. The investor relations module 28 may include information related to the IP Trust governance, operation, management, board of directors, patent contributors, and other information that may be relevant to the investment community.

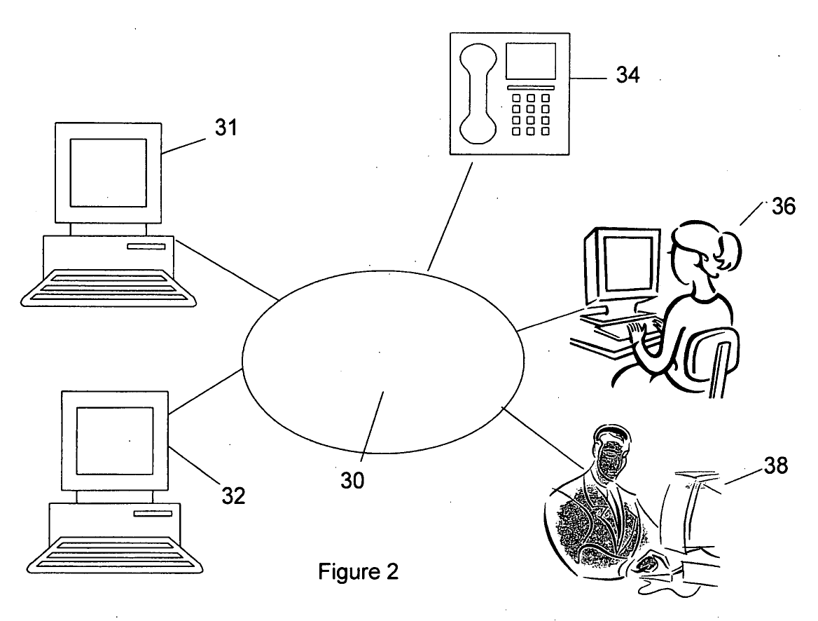

The system 10 may be web-based, allowing for multiple access by administrators, developers, investors, owners, licenses and other interested parties. Alternatively, the system may be implemented on client-server systems, kiosks, within or in conjunction with a telecommunication system, including mobile telecommunication system, or any other type of system. With reference to FIG. 2, one embodiment of the system 10 is illustrated. The IP Trust manager may manage the IP trust using system workstation 31 connected to network 30. An administrator may provide system administrative functions from workstation 32, also connected to network 30. Investors may have access to the system 10 through workstation interface 36 or telephone interface 34, each of which is also connected through the network 30. Licensees may have access to the system 10 through workstations 38, also connected to network 30. Workstations 31, 32, 36, and 38 may be any type of computer based workstations, including desktops, laptops, netbooks, or handheld computers or mobile communications devices such as smartphones, PDAs, and web-enabled phones. The telephone interface 34 may be implemented by any type of voice communication device. Network 30 preferably has an interactive voice response or other automated system (not shown). Network 30 may be an internet, telecommunications, wi-fi, wireless, local area or wide area network, or any other type of network now known or to be developed.

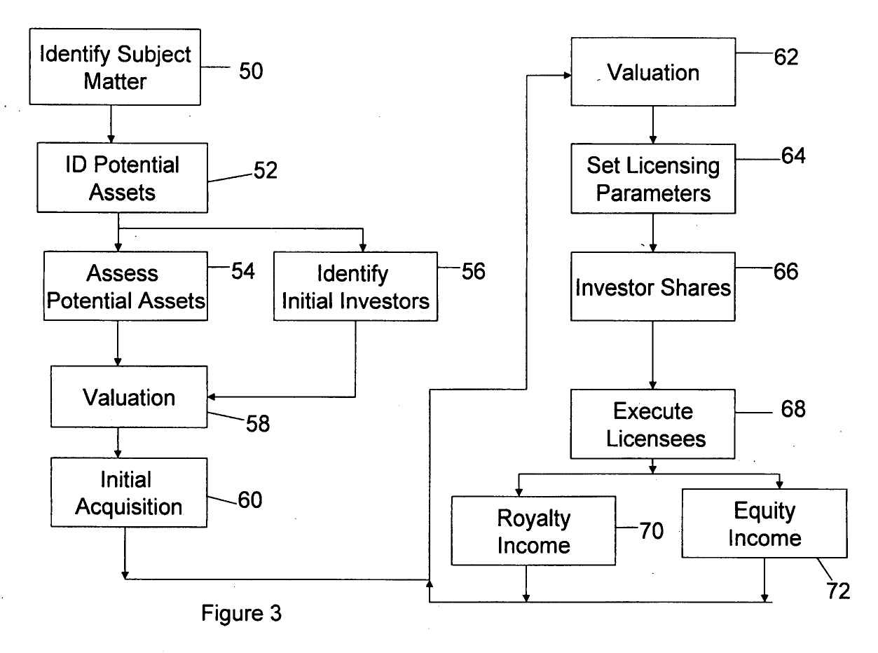

Turning now to FIG. 3, a method of implementing one embodiment of the present invention is shown. It will be understood that the method need not be practiced in any particular order or that all of the potential steps of the method need not be practiced to fall within the scope of the claims. At block 150, the IP Trust manager identifies the subject matter and/or technology to be associated with the IP Trust. At block 152, the potential assets of the trust are identified, including the developer, assignee, current owner, and perhaps lien holder associated with each of the assets. At block 54, the potential assets are assessed for quality, fit, age, and other criteria set forth by the IP Trust. In parallel with that assessment, initial investors are identified, which could be private individuals, mutual funds, venture funds, banks or any other type of investment funding source. At block 58, the valuation of the assets takes place, in which the valuation is a function of the assessment and the number and quality of potential investors and initial contributors. At block 60, the initial acquisition of the assets occurs.

Continuing with reference to FIG. 3, the valuation may be revised at block 62 based on the actual and not potential assets acquired by the IP Trust. At block 62, the IP Trust sets the licensing parameters, including the material terms and conditions of licensees and licensing rates. The licensing parameters may include royalty rates based on running royalties or paid up royalties. There may also be an option for royalties to be based on IP contributions made by licensees. Additionally, there may be an option for potential licensees to purchase shares in the IP Trust (known as Equity licensees).

At block 66, shares of the IP Trust are allocated to investors, initial contributors, and any overhead types of shares as well as shares targeted for trading. At block 168, licensees are identified and license agreements are finalized. As a result of the licenses, the IP trust receives consideration in the form of royalty income at block 70 from those licensees paying royalties and equity income and/or equity appreciation from those licensees opting to purchase equity and/or contribute additional intellectual property in consideration for a license. With each license, the valuation process may be reset at step 62. Not shown is the secondary market for shares of IP Trusts, in which initial investors, initial contributors, or equity licensees may sell shares to other investors or new investors privately or on the public exchanges.

Thus, there has been described systems and methods for creating and realizing value from intellectual property in the form of a novel and nonobvious concept of IP Trusts. Those skilled in the art will appreciate that numerous changes and modifications can be made to the preferred embodiments of the invention, and that such changes and modifications can be made without departing from the spirit of the invention. It is intended, therefore, that the appended claims cover all such equivalent variations as fall within the true spirit and scope of the invention.

What is claimed:

1. A method for extracting value from intellectual property comprising:
collecting intellectual property assets in an investment vehicle;
selling shares in the investment vehicle; and
licensing the collected intellectual property through the investment vehicle.
